(19) United States
(12) Patent Application Publication
(10) Pub. No.: US 2024/0155205 A1
(43) Pub. Date: May 9, 2024

(54) METHOD FOR GENERATING CAPTIONS, SUBTITLES AND DUBBING FOR AUDIOVISUAL MEDIA

(71) Applicant: SYNCWORDS, NEW YORK, NY (US)

(72) Inventors: ASHISH SHAH, NEW YORK, NY (US); SOTIRIS CARTSOS, NEW YORK, NY (US); ALEKSANDR DUBINSKY, NEW YORK, NY (US)

(73) Assignee: SYNCWORDS, NEW YORK, NY (US)

(21) Appl. No.: 18/403,829

(22) Filed: Jan. 4, 2024

Related U.S. Application Data
(63) Continuation-in-part of application No. 16/810,588, filed on Mar. 5, 2020, now Pat. No. 11,942,093.
(60) Provisional application No. 63/479,364, filed on Jan. 11, 2023.

(51) Int. Cl. H04N 21/488; G10L 13/08; G10L 15/26; H04N 21/81

(52) U.S. Cl. CPC H04N 21/4884; G10L 13/086; G10L 15/26; H04N 21/8106

(57) ABSTRACT

The method for generating captions, subtitles and dubbing for audiovisual media uses a machine learning-based approach for automatically generating captions from the audio portion of audiovisual media, and further translates the captions to produce both subtitles and dubbing. A speech component of an audio portion of audiovisual media is converted into at least one text string which includes at least one word. Temporal start and end points for the at least one word are determined, and the at least one word is visually inserted into the video portion of the audiovisual media. The temporal start and end points for the at least one word are synchronized with corresponding temporal start and end points of the speech component of the audio portion of the audiovisual media. A latency period may be selectively inserted into broadcast of the audiovisual media such that the synchronization may be selectively adjusted during the latency period.

### CROSS-REFERENCE TO RELATED APPLICATIONS

This application is a continuation-in-part of U.S. patent application Ser. No. 16/810,588, filed on Mar. 5, 2020, which claimed the benefit of U.S. Provisional Patent Application No. 62/814,419, filed on Mar. 6, 2019, and further claims the benefit of U.S. Provisional Patent Application No. 63/479,364, filed on Jan. 11, 2023.

### BACKGROUND

### Field

The disclosure of the present patent application relates to audiovisual media, such as streaming media programs and the like, and particularly to a method for generating closed captioning, subtitles and dubbing for audiovisual media.

### Description of Related Art

Speech-to-text has become relatively common for converting spoken words into corresponding written or visual text. The generation of captioning for video presentations, such as television programs and movies, was once performed by human transcription and manual transcription into the frames of video. This process can now be performed automatically using a speech-to-text algorithm coupled with video editing software. However, speech-to-text conversion is not perfect and, when applied to television programs, movies, webinars, etc., the accuracy of the captions can be relatively poor, particularly when the speech-to-text algorithm transcribes words which are not common, such as proper nouns or acronyms.

Conversion of captioning into foreign language subtitles can also be performed automatically using translation software. However, similar to the problems inherent in speech-to-text discussed above, the translations can lack accuracy, particularly when words and phrases are given their literal translations rather than idiomatic and culture-specific translations. The generation of automatic dubbed voices suffers from the same problems, with the added issue of artificially generated voices lacking the emotion and tonality of the original speaker, as well as lacking the vocal qualities associated with the age and gender of the original speaker. Thus, a method for generating captions, subtitles and dubbing for audiovisual media solving the aforementioned problems is desired.

### SUMMARY

The method for generating captions, subtitles and dubbing for audiovisual media uses a machine learning-based approach for automatically generating captions from the audio portion of audiovisual media (e.g., a recorded or streaming program or movie), and further translates the captions to produce both subtitles and dubbing. In order to increase accuracy and enhance the overall audience experience, the automatic generation of the captions, subtitles and dubbing may be augmented by human editing.

A speech component of an audio portion of audiovisual media is converted into at least one text string, where the at least one text string includes at least one word. Temporal start and end points for the at least one word are determined, and the at least one word is visually inserted into the video portion of the audiovisual media. The temporal start point and the temporal end point for the at least one word are synchronized with corresponding temporal start and end points of the speech component of the audio portion of the audiovisual media. A latency period may be selectively inserted into broadcast of the audiovisual media such that the synchronization may be selectively adjusted during the latency period.

The text strings typically include more than one word, forming phrases and sentences, and visual segmentation of the plurality of words may be selectively adjusted. This adjustment of the segmentation may be performed automatically by a machine learning-based system, and may be further augmented by human editing performed during the latency period.

To create subtitles, the at least one word is translated into a selected language prior to the step of visually inserting the at least one word in the video portion of the audiovisual media. Typically, as discussed above, a plurality of words are provided, and the timing of pauses between each word may be determined. Additionally, groups of the plurality of words which form phrases and sentences may be determined from the temporal start and end points for each of the words. Temporal anchors may be assigned to each of the words, phrases and sentences.

At least one parameter associated with each of the words, phrases and sentences may be determined. Non-limiting examples of such parameters include identification of a speaker, a gender of the speaker, an age of the speaker, an inflection and emphasis, a volume, a tonality, a raspness, an emotional indicator, or combinations thereof. These parameters may be determined from the speech component of the audio using a machine learning-based system. The at least one parameter of each of the words, phrases and sentences may be synchronized with the temporal anchors associated therewith.

Following translation, determination of the parameter(s) and synchronizing of the parameter(s), each of the words, phrases and sentences may be converted into corresponding dubbed audio, which is embedded in the audio portion of the audiovisual media corresponding to the temporal anchors associated therewith. The at least one parameter may be applied to the words, phrases and sentences in the dubbed audio. During the latency period, at least one quality factor associated with the dubbed audio (e.g., synchronization, volume, tonal quality, pauses, etc.) may be edited by a human editor. During the editing process within the latency period, a countdown may be displayed to the user, indicating the remaining time for editing within the latency period.

These and other features of the present subject matter will become readily apparent upon further review of the following specification.

### BRIEF DESCRIPTION OF DRAWINGS

FIG. 1 is a block diagram illustrating an overview of a system and method for generating captions, subtitles and dubbing for audiovisual media.

FIG. 2A diagrammatically illustrates a speech-to-text component of the method for generating captions, subtitles and dubbing for audiovisual media distinguishing between words, phrases and sentences based on pauses between words.

FIG. 2B illustrates parameters associated with each word, phrase and sentence that are detected in the method for generating captions, subtitles and dubbing for audiovisual media.

FIG. 3 is a high level flow diagram illustrating steps of the method for generating captions, subtitles and dubbing for audiovisual media.

FIG. 4 is a flow diagram illustrating steps for caption generation in the method for generating captions, subtitles and dubbing for audiovisual media.

FIG. 5 is a flow diagram illustrating steps for subtitle generation in the method for generating captions, subtitles and dubbing for audiovisual media.

FIG. 6 is a flow diagram illustrating steps for generation of dubbing in the method for generating captions, subtitles and dubbing for audiovisual media.

Similar reference characters denote corresponding features consistently throughout the attached drawings.

### DETAILED DESCRIPTION

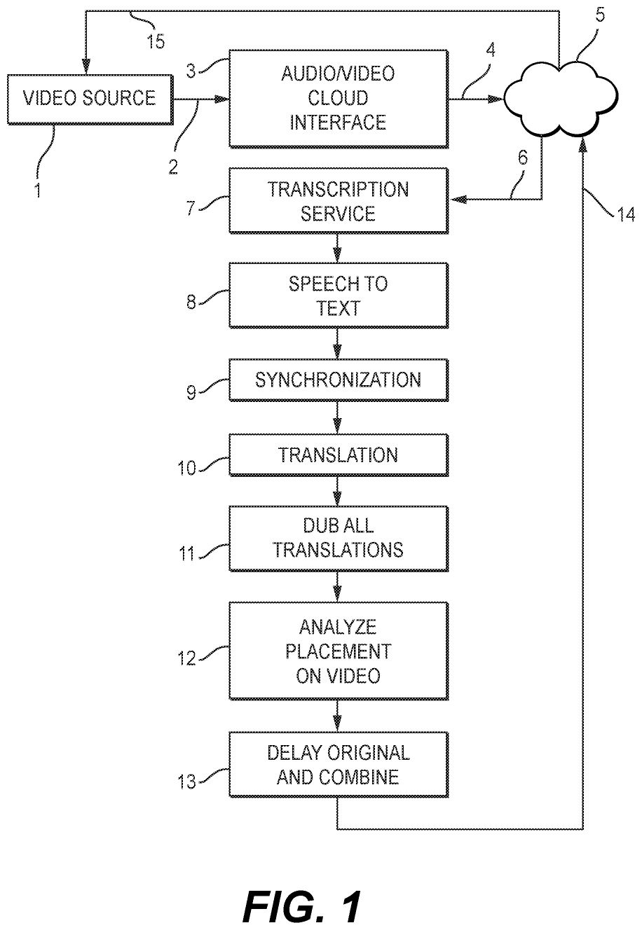

Referring now to FIG. 1, in an exemplary embodiment, a video program containing both audio and video is transmitted from a video source 1 via element 2 to a device 3 that processes the program and transmits it via element 4 to a cloud network 5. It should be understood that elements 2 and 4 may be any suitable transmission pathways, such as wired or wireless data transmission, a local area network (LAN), or a wide area network (WAN), such as the internet or the like. It should be further understood that the video program may be a conventional video program such as that commonly streamed over the internet, as a non-limiting example, including a series of video frames and an audio track. Device 3 may be any suitable type of interface, such as a cloud interface or the like, capable of receiving the unprocessed video from source 1 or transmitting the finished video back to source 1. As a non-limiting example, the video source 1 may be a broadcast station or a web streaming service. It should be further understood that, as an alternative, cloud processing may be eliminated. A LAN, WAN or the internet, as non-limiting examples, may be substituted for cloud network 5. Further, it should be understood that there may alternatively be a direct connection via element 6 from element 2 to transcription service 7, which may be on a separate computer or server. It should be understood that element 6 may be any suitable type of transmission pathway.

The video program is transmitted via element 6 to transcription service 7, either directly or indirectly, as discussed above, and transcription service 7 produces a text script of the audio program in the originally recorded language using a speech-to-text engine 8. Alternatively, or in conjunction with speech-to-text engine 8, human transcription may be used. Speech-to-text software running on speech-to-text engine 8 may recognize phonemes and may use a dictionary to form words. The speech-to-text engine 8 may use artificial intelligence to distinguish between various speakers and to assign the text strings to those speakers.

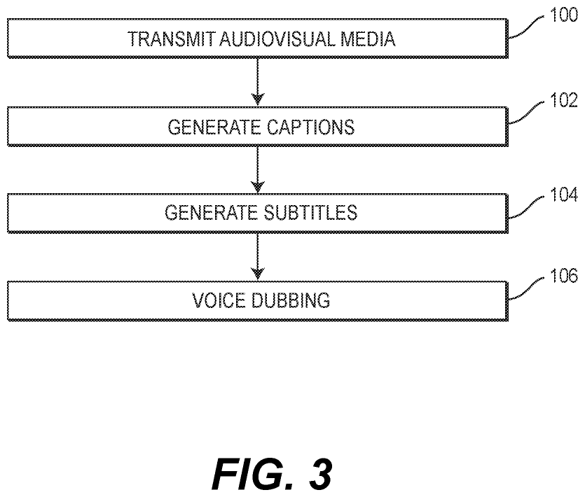

With reference to FIG. 3, the transmission of the video program described above is initially transmitted at step 100, and the transcription service 7 discussed above is used to produce captions; i.e., plain text which is converted from the speech found in the audio component of the transmitted audiovisual media (such as a conventional streamed video program, movie or the like). At step 102, the captions are generated using speech-to-text engine 8 and/or human transcription. As used herein, the term “captions” refers to the verbatim text of the speaker in the audio in the original spoken language. These captions may be used directly for closed captioning of the video. It should be understood that the speech-to-text engine 8 may use any suitable type of speech-to-text algorithm(s), processing or the like. It should be further understood that speech-to-text engine 8 may be, or may be incorporated in, any suitable type of computer, server, network server, cloud server, distributed computing network or the like.

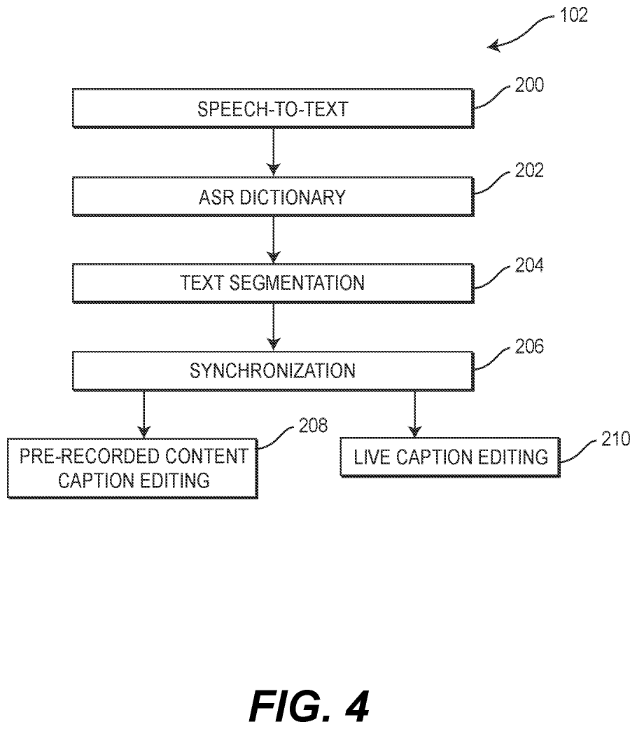

The speech-to-text engine 8 may automatically produce the captions using automatic speech recognition (ASR) to generate text from the source audio. With reference to FIG. 4, during the generation of the captions, initial direct speech-to-text processing is performed at step 200 and, in order to improve accuracy of the ASR, the initial text of the captions is compared against stored words and other text contained in an ASR dictionary. The ASR dictionary may be stored in a database in computer readable memory associated with transcription service 7 or, as an alterative, may be stored remotely, for example. As a non-limiting example, the ASR dictionary may be stored as a text or XML file containing the correct spellings of selected words and other text. As non-limiting examples, proper nouns, such as names of people and names of places, may be stored in the ASR dictionary. Acronyms and commonly used initials are also non-limiting examples of text which may be stored in the ASR dictionary. Overall, words and text which are commonly used in speech in a particular language, but which may be difficult for a conventional speech-to-text engine to translate, may be stored in the ASR dictionary. Multiple ASR dictionaries may be employed for different languages and/or different cultures. During the comparison of words with the ASR dictionary in step 202, the transcription service 7 may replace the original generated text with the properly spelled text found in the ASR dictionary. It should be understood that the transcription service 7 may be, or may be incorporated in, any suitable type of computer, server, network server, cloud server, distributed computing network or the like.

Following comparison with the ASR dictionary in step 202, transcription service 7 determines the best way to display the captions in the video. At step 204, the text is properly segmented to break up the displayed text to make reading the captions as easy and natural as possible. Thus, appropriate line breaks are inserted, proper nouns are inserted in the same line (as much as possible), the amount of text in each displayed line of text is visually balanced, etc. Segmentation may be performed using machine learning trained on a corpus of closed captions from previous video programs, movies, etc.

Further, the overall system also transcribes and synchronizes inflection, emphasis, and volume variations in the text. The system is capable of distinguishing between male and female speakers (including children) and assigns these identification parameters to the text. The identification parameters may include a “raspness” index to add character to the voice. A synchronizer 9 automatically attaches timing parameters to each word in the text string. These timing parameters measure the temporal length of each word and synchronize the inflection, emphasis, and volume indicators with various temporal points within each string. It should be understood that the synchronizer 9 may be, or may be incorporated in, any suitable type of computer, server, network server, cloud server, distributed computing network or the like.

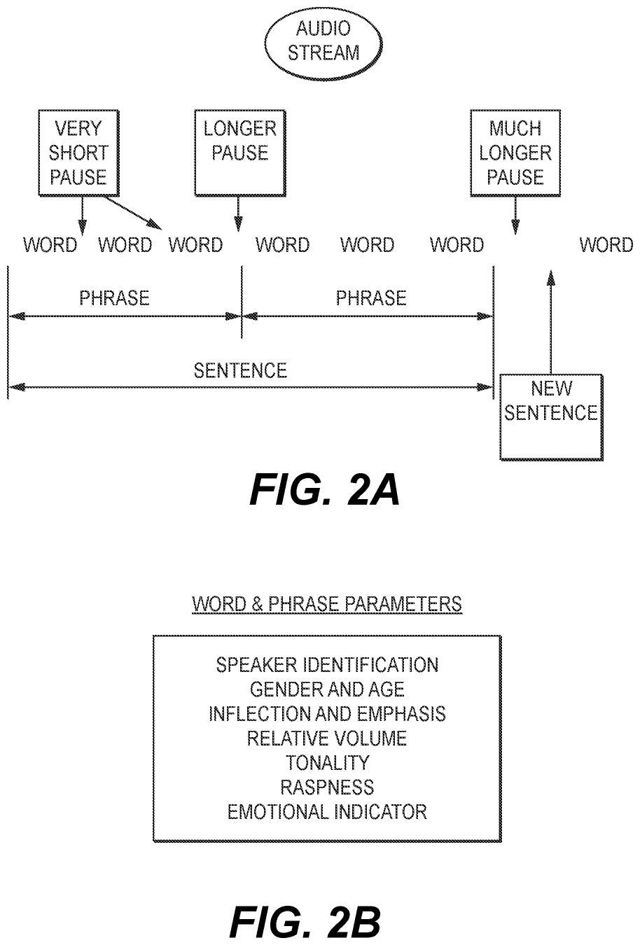

The timing parameters establish the start time and the end time for each word. In this way, the transcription algorithm can measure the temporal length of pauses in speech. FIG. 2A diagrammatically illustrates how timing of pauses is used to analyze the text. The shortest pauses are between words continuously strung into a phrase. There are longer pauses between phrases, and even longer pauses between sentences. Very long pauses indicate that there is no speech to transcribe. Thus, an audio stream may be transcribed into words that are grouped in phrases and sentences. Sentences include one or more phrases. The parameters to be collected are shown in FIG. 2B. In any phrase, emphasis will often be on its last word. For the word determined to have the most emphasis, the word will have greater intensity of volume. Although assignment of volume is not used in plain speech-to-text processing, the volume parameter will have importance with regard to later translation processing, as will be discussed in detail below. Within a given phrase, there will be some words having greater relative volume than the other words, with the last word often having greater relative volume than the others. Emphasis is established using relative volume. Further, any given phrase is known to be spoken by the same person. Thus, the parameters of gender and age will remain constant within the phrase. With rare exceptions, this will also apply to sentences.

An artificial intelligence component of the software determines the emotional aspect of each phrase or sentence. This is determined by the way words are uttered in sequence. Software can detect when a person is whining, for example, by the tonality of words, their location in a phrase or sentence, and how fast the words are uttered relative to each other. The software is able to detect when speakers are happy, sad, frightened, etc. FIG. 2B illustrates a non-limiting example of parameters associated with spoken words and phrases which can be determined using artificial intelligence. It should be understood that any suitable type of machine learning algorithm(s) may be applied to extract these parameters from the original spoken audio. The non-limiting example of parameters illustrated in FIG. 2B includes speaker identification, gender and age, inflection and emphasis, relative volume, tonality, raspness, and emotion.

Returning to FIG. 4, the synchronization performed by synchronizer 9 is shown at step 206. For both live and pre-recorded media, it is important that the captions be timed (or “synced”) accurately with the media. Machine learning may be used to accurately align the caption text and the media. For pre-recorded video, the highest confidence word timings generated in the ASR may be used as default time stamps, around which synchronization is performed. For non-romance languages, synchronizer 9 may convert the text into phonemes which can be synced with the media. For live video, synchronizer 9 induces a delay to the video stream and, in real time, syncs the text with the media using the time stamps, thus giving the user an experience of watching properly synced captions.

For pre-recorded media, caption editing may take place at step 208. During pre-recorded content caption editing, a human editor may use a software tool to edit the generated caption text alongside the video, enabling the editor to correct the alignment or synchronization of the media and caption text, edit the caption text, and/or edit the segmentation of the text within each caption.

For live media (e.g., streaming video which is being transmitted in real time), live caption editing may take place at step 210, allowing the editor to perform similar edits to the captions, but in real time with respect to the live media. Similar to the pre-recorded editing described above, the editor may use a software tool to perform review and editing of the close captioning for the live media. As will be discussed in further detail below, this live editing process may also allow the editor to review and edit subtitle translation and accuracy, as well as the quality of dubbed voices. In order to perform the editing, a configurable latency is inserted into the media broadcast. As a non-limiting example, the latency period may be on the order of a minute or less, such as about 30 seconds.

The software tool used by the live editor may provide the editor with a display of a countdown, for example, to show the time remaining within the inserted latency to perform any needed edits. As will be discussed in greater detail below, subtitles may be generated using machine translation of the caption text, and dubbed voices may be generated using text-to-speech from the translated caption text. Each of these processes may have its own latency associated therewith. Each output stream is locked after a specified latency. When the live closed captioning text is used for real time translated subtitles and real time dubbed voices, the latency for the live closed captioning must be less than the latency used for translated subtitles and dubbed voices. The software tool used by the editor may include a timer which allows for a variable offset (or difference in latency) for each output stream. Assuming an offset is applied, the timer provides a countdown, indicating the remaining time available to edit each block of text, and then locks text for further processing and delivery.

The text strings are simultaneously translated phrase-by-phrase into multiple languages by translation engine 10. The system then produces multiple scripts, each containing a series of concatenated text strings representing phrases along with associated inflection, emphasis, volume and emotional indicators, as well as timing and speaker identifiers, that are derived from the original audio. Each text string in both the untranslated and translated versions has a series of timing points. The system synchronizes these timing points of the words and phrases of the translated strings to those of the untranslated strings. It is important that the translated string retains the emotional character of the original source. Thus, intonations of certain words and phrases in both the translated and source text strings are retained, along with volume, emphasis, and relative pause lengths within the strings.

Within a phrase, the number and order of words might be different for different languages. This is based on grammar discrepancies in different languages. As a non-limiting example, in German, verbs normally appear at the end of a phrase, as opposed to English where subjects and verbs are typically found in close proximity to one another. Single words can translate to multiple words and vice versa. For example, in many languages, the word for potato literally translates as “earth apple.” In French, this translation has the same number of syllables, but in other languages, there could be more or less syllables. This is why it is difficult to translate songs from one language to another while keeping the same melody. It is important that the beginning and end temporal points for each phrase are the same in the original source text and the translated target text. Thus, when translated voice dubbing occurs, speech cadence in the dubbed translation may be sped up or slowed down so that temporal beginning and end points of any phrase will be the same in any language.

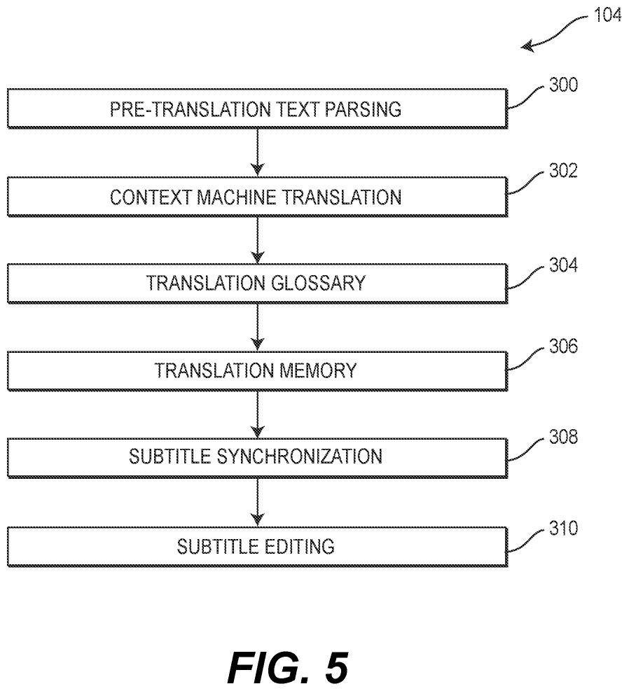

The generation of subtitles described above occurs at step 104 in FIG. 3. As discussed above, at step 104, the subtitles are initially generated by translating the caption text (generated at step 102) in its original source language. The translations may be performed using machine learning and/or machine translation, with translation engine 10 either being located locally or remotely. As shown in FIG. 5, the process begins with pre-translation text parsing at step 300. Sentence-level detection of the generated caption text is performed and sentence-level segments of the text are transmitted to translation engine 10. By sending entire sentences, rather than individual words or phrases, a higher translation accuracy is achieved. It should be understood that the translation process may be applied to either the live (real time) subtitle generation process or the pre-recorded subtitle generation process. It should be understood that the translation engine 10 may be, or may be incorporated in, any suitable type of computer, server, network server, cloud server, distributed computing network or the like.

Context machine translation is performed at step 302. In this step, the entire transcript, or discrete paragraphs of the transcript, are translated in whole so that the context of the text may be used in the sentences to give the translations more semantic meaning. At step 304, the translated text is compared against a translation glossary, which is an index of specific terminology with approved translations in target languages. The translation glossary may be stored in a database in computer readable memory, either locally or remotely, and contains words and phrases which are specific to the particular language of the translation glossary. It should be understood that multiple translation glossaries may be used, corresponding to the various languages into which the captions are being translated. Replacement of certain translated words and phrases with those found in the translation glossary preserves the indexed words and phrases (e.g., proper nouns) from being literally translated when literal translation is not appropriate. Similarly, at step 306, the translated text may be compared against text saved in a translation memory, which may be stored in a database in computer readable memory, either locally or remotely, and contains sentences, paragraphs and/or segments of text that have been translated previously, along with their respective translations in the target language.

Subtitle synchronization is performed at step 308. The subtitles may be synced in real time by adjusting the latency of the media stream and matching the sync of the translated subtitles using the time stamps created during the ASR caption generation. Further, as discussed above with regard to caption editing, at step 310, a human editor may edit the subtitles. As discussed above, a software tool may be provided for editing the translated text alongside the video, and also alongside the corresponding source text. This allows the editor to correct the alignment or sync of the media and text, edit the text, and also improve the segmentation of the text within each caption. As discussed above, this may either be performed on pre-recorded media or may be performed during an inserted latency period for live broadcasting of the media.

When closed captioning (CC) is desired, the translated text is either flashed or scrolled onto the screen as subtitles. The system has the ability to determine the placement of the subtitles on the screen so as not to interfere with the focus of the video program content. It should be understood that the closed captioning text is not necessarily translated text. In other words, in order to produce closed captioning, the above process may be performed but without translation into other languages. As commonly used, “closed captioning” refers to text in the original language, whereas a “subtitle” typically refers to text which has been translated into the language of the audience.

An analysis module 12 may be used to analyze the placement and superposition of the closed captioning and/or subtitles onto the original video program. Once this has been done (using artificial intelligence), the dubbed video is sent back to the cloud via element 14, and then back to video source 1 via element 15. As discussed above, when occurring in real time (i.e., when the above process is implemented when the video is being transmitted or streamed to the audience), at step 13 in FIG. 1, transmission is delayed to allow synchronization of the dubbed audio to the video. However, the delay is very short, typically on the order of a fraction of a minute. As discussed above, analysis module 12 is used to determine the best way to display the text in the video, particularly with regard to proper segmentation of the text to break up the displayed text to make reading the captions or subtitles as easy and natural as possible. Thus, appropriate line breaks are inserted, the amount of text in each displayed line of text is visually balanced, etc. Segmentation may be performed using machine learning trained on a corpus of closed captions and/or subtitles from previous video programs, movies, etc. It should be understood that the analysis module 12 may be, or may be incorporated in, any suitable type of computer, server, network server, cloud server, distributed computing network or the like.

Voice dubbings are created from the text strings using a text-to-speech module. All of the parameters contained in the text strings associated with each word, phrase and sentence are used to create the audio stream. Thus, speech made by a person in the target language will sound exactly like the speech made by the same person in the source language. All of the voice and emotional characteristics will be retained for each person in each phrase. It will appear as if the same speaker is speaking in a different language.

Multiple language dubbings are simultaneously produced for all translated scripts using dubbing engine 11. Text-to-speech synthesizers may be used to create audio strings in various languages, corresponding to phrases, that are time synchronized to their original language audio strings. Corresponding translated words are given the same relative volume and emphasis indicators as their source counterparts. Each audio string has multiple temporal points that correspond to those in their respective text strings. In this way, the translated language strings fully correspond in time to the original language strings. Various speakers are assigned individual voiceprints based on gender, age and other factors. The intonation, emphasis and volume indicators ensure that the voice dubbings sound realistic and as close to the original speaker's voice as possible. It should be understood that the dubbing engine 11 may be, or may be incorporated in, any suitable type of computer, server, network server, cloud server, distributed computing network or the like.

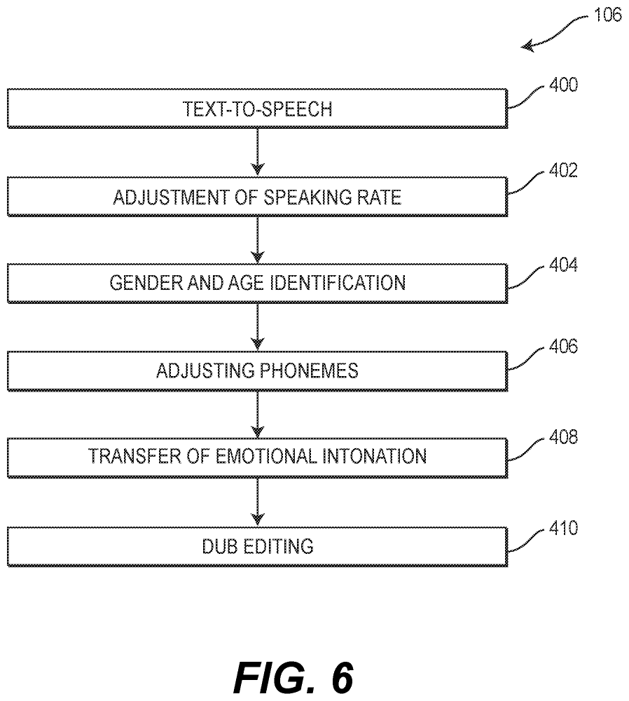

At step 106, voice dubbing is performed to generate voice dubs from the translated text (generated in step 104) using an artificially intelligent text-to-speech (TTS) engine run on dubbing engine 11, which may either be located locally or remotely. With reference to FIG. 6, following text-to-speech conversion at step 400, based on the speed of the subtitles translated, each subtitle at a time, dubbing engine 11 adjusts the speaking rate for the subtitle, keeping the level between a band of values. The band of values of the speaking rate (i.e., the high and low levels of the speaking rate) vary by language spoken. In other words, dubbing engine 11 adjusts the speaking rate to be within a set range of rates associated with each particular language.

As discussed above, machine learning is used to analyze the original speech found in the original audio of the media in order to determine a wide variety of factors, including age and gender of each speaker. At step 404, based on the gender and age of the speaker, dubbing engine automatically provides an appropriate TTS voice. The identification of gender and age can also be indicated in the subtitles or can be automatically detected by the TTS engine.

At step 406, words may be spelled out by their phonemes so they can be pronounced correctly by the TTS engine. As a non-limiting example, dubbing engine 11 may use Speech Synthesis Markup Language (SSML), which is a markup language that provides a standard way to mark up text for the generation of synthetic speech. The editor's software tool discussed above, for example, may include an interface for using SSML tags to control various aspects of the synthetic speech production, such as pronunciation, pitch, pauses, rate of speech, etc.

As discussed above, machine learning may be used to analyze the original voices of the speakers in the original audio for, for example, age, gender, intonation, stress, and pitch rhythms. At step 408, a generative artificial intelligence (AI) model may be used for the TTS. The dubbing engine 11 transfers the original intonation, stress, and pitch rhythm factors from the original voice of the speaker into the synthesized voice of the speaker in the new language. As a non-limiting example, a model based on the Tacotron architecture may be used, allowing for the generation of human speech while mimicking the speaker's voice and preserving the original speaking style.

The generative AI model may include, as a non-limiting example, a text encoding block, a speaker extractor (for capturing important speaker voice properties), and a prosody modeling block, which allows performing expressive synthesis by copying original intonation, stress, and rhythm factors. The generative AI model may also allow for the regulation of the speaking speed by using a duration predictor block. This block can predict relevant durations or use explicitly defined durations provided via a voice editing tool. Duration boundaries can be specified for words or phoneme level. Additionally, a vocoder model may be used for producing waveform based on the output of the generative AI model. The generative AI model may perform speech synthesis in two modes: pretraining (i.e., training the speaker voice by processing the reference media, which produces higher quality) or inferred voice (which is performed faster but with lower quality).

Alternatively, TTS with emotional intonation may be generated using an autoregressive transformer that can perform speech synthesis but produces stochastic outputs (i.e., the resulting speech is different after each synthesis). This autoregressive transformer may resemble the GPT language model, for example, which is adapted for speech synthesis. Although this model does not allow for explicitly controlling durations like the above generative AI model, it can resynthesize speech from any moment (i.e., after a selected moment in time, the model can generate a new continuation).

Further, as discussed above with regard to caption editing and subtitle editing, at step 410, a human editor may edit the voice dubs. As discussed above, a software tool may be provided for editing the voice dubs alongside the video, and also alongside the corresponding source text and/or translated subtitles. This allows the editor to correct the alignment or sync of the media and dubbing, edit the dubbing, and also improve various qualities of the voice dubs. As discussed above, this may either be performed on pre-recorded media or may be performed during an inserted latency period for live broadcasting of the media.

As discussed above, various aspects of the present method may be performed either on live broadcast media or on pre-recorded media. In such an “offline” implementation, where editing may be performed on pre-recorded media without the necessity of inserting latency periods into the media, the process functions in a similar manner to the real time implementation, except that more humans may be added into the loop to effect cleanup and quality control. The primary difference is that the offline implementation provides more accuracy due to human intervention. The following represents some of the workflow differences that may occur with the offline implementation: humans may transcribe the audio rather than relying on a machine transcription; the transcription may be better synchronized with the speech; there is more opportunity for quality control; human language translation is often more accurate and localized than machine language translation; and a graphical user interface (GUI) interface may be used to edit the synthetic dubbed audio. Such editing may be applied to the following features: audio volume (loudness or softness); compression of the words to comply with the rate of speech; and intonation (emphasis of the words and voice can be adjusted to be the same as in the originally recorded speech). Other cleanup tools may include editing speech-to-text; editing timing; editing diarization; and editing the prosody/intonation, voice, and other aspects of generated speech.

It should be understood that processing at each step may take place on any suitable type of computer, server, mobile device, workstation or the like, including the computer, workstation, device or the like used by a human editor, as discussed above. It should be further understood that data may be entered into each computer, sever, mobile device, workstation or the like via any suitable type of user interface, and may be stored in memory, which may be any suitable type of computer readable and programmable memory and is preferably a non-transitory, computer readable storage medium. Calculations may be performed by a processor or the like, which may be any suitable type of computer processor or the like, and may be displayed to the user on a display, which may be any suitable type of computer display. It should be understood that the processor or the like may be associated with, or be incorporated into, any suitable type of computing device, for example, a personal computer or a programmable logic controller. The display, the processor, the memory and any associated computer readable recording media are in communication with one another by any suitable type of data bus, as is well known in the art. Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to the memory, or in place of the memory, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

It is to be understood that the method for generating captions, subtitles and dubbing for audiovisual media is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method for generating captions for audiovisual media, comprising the steps of:
converting a speech component of an audio portion of audiovisual media into at least one text string, wherein the at least one text string comprises at least one word;
determining a temporal start point and a temporal end point for the at least one word;
visually inserting the at least one word in a video portion of the audiovisual media such that the temporal start point and the temporal end point for the at least one word are synchronized with corresponding temporal start and end points of the speech component of the audio portion of the audiovisual media; and
selectively inserting a latency period into broadcast of the audiovisual media such that the synchronization may be selectively adjusted during the latency period.

2. The method for generating captions for audiovisual media as recited in claim 1, wherein the at least one word comprises a plurality of words, and wherein the method further comprises selectively adjusting visual segmentation of the plurality of words.

3. The method for generating captions for audiovisual media as recited in claim 2, wherein the selective adjustment of the visual segmentation of the plurality of words is performed during the latency period.

4. The method for generating captions for audiovisual media as recited in claim 2, wherein the selective adjustment of the visual segmentation of the plurality of words is performed by a machine learning-based system.

5. The method for generating captions for audiovisual media as recited in claim 1, further comprising the step of translating the at least one word into a selected language prior to the step of visually inserting the at least one word in the video portion of the audiovisual media.

6. The method for generating captions for audiovisual media as recited in claim 5, wherein the at least one word comprises a plurality of words, the method further comprising the step of determining a timing of pauses between each of the words.

7. The method for generating captions for audiovisual media as recited in claim 6, further comprising the step of determining groups of the plurality of words which form phrases and sentences from the temporal start and end points for each of the words.

8. The method for generating captions for audiovisual media as recited in claim 7, further comprising the step of assigning temporal anchors to each of the words, phrases and sentences.

9. The method for generating captions for audiovisual media as recited in claim 8, further comprising the step of determining at least one parameter associated with each of the words, phrases and sentences.

10. The method for generating captions for audiovisual media as recited in claim 9, wherein the at least one parameter is selected from the group consisting of identification of a speaker, a gender of the speaker, an age of the speaker, an inflection and emphasis, a volume, a tonality, a raspness, an emotional indicator, and combinations thereof.

11. The method for generating captions for audiovisual media as recited in claim 10, wherein the at least one parameter is determined using a machine learning-based system.

12. The method for generating captions for audiovisual media as recited in claim 10, further comprising the step of synchronizing the at least one parameter of each of the words, phrases and sentences with the temporal anchor associated therewith.

13. The method for generating captions for audiovisual media as recited in claim 12, further comprising the steps of converting each of the words, phrases and sentences into corresponding dubbed audio.

14. The method for generating captions for audiovisual media as recited in claim 13, further comprising the step of embedding the dubbed audio in the audio portion of the audiovisual media corresponding to the temporal anchors associated therewith.

15. The method for generating captions for audiovisual media as recited in claim 14, further comprising the step applying the at least one parameter to the words, phrases and sentences of the dubbed audio prior to the step of embedding the dubbed audio in the audio portion of audiovisual media.

16. The method for generating captions for audiovisual media as recited in claim 15, further comprising the step of selectively adjusting at least one quality factor associated with the dubbed audio during the latency period.

17. The method for generating captions for audiovisual media as recited in claim 1, further comprising the step of displaying a countdown to a user, wherein the countdown indicates a remaining time during the latency period.
